(19) United States
(12) Patent Application Publication
(10) Pub. No.: US 2007/0014656 A1
(43) Pub. Date: Jan. 18, 2007

(54) End-effectors and associated control and guidance systems and methods

(76) Inventors: Randy A. Harris, Kalispell, MT (US); Daniel J. Woodruff, Kalispell, MT (US); Paul Wirth, Columbia Falls, MT (US); David P. Mattson, Kalispell, MT (US); James J. Erickson, Kalispell, MT (US)

Correspondence Address: PERKINS COIE LLP, P.O. BOX 1247, PATENT-SEA, SEATTLE, WA, 98111-1247, US

(21) Appl. No.: 11/480,313

(22) Filed: Jun. 29, 2006

Related U.S. Application Data
(63) Continuation-in-part of application No. 10/195,137, filed on Jul. 11, 2002.
(63) Continuation-in-part of application No. 11/177,937, filed on Jul. 7, 2005.

(51) Int. Cl. B66C 23/00

(52) U.S. Cl. 414/744.5

(57) ABSTRACT

End-effectors and associated control and guidance systems and methods are disclosed. A transfer device in one embodiment includes a base unit, an arm carried by the base unit and movable relative to the base unit, and an end-effector carried by the arm and rotatable relative to the arm. The end-effector includes two grippers, at least one being movable toward and away from the other between a grip position and a release position. A transmission is coupled between a motor and the movable gripper to receive an input force from the motor and apply an output force to the gripper that increases as the gripper moves to the grip position.

### CROSS-REFERENCE TO RELATED APPLICATIONS

The present application is a continuation-in-part of U.S. application Ser. No. 10/195,137, filed Jul. 11, 2002 and entitled “End-Effectors for Handling Microelectronic Workpieces,” and U.S. application Ser. No. 11/177,937, filed Jul. 7, 2005 and entitled “End-Effectors for Handling Microfeature Workpieces,” both of which are incorporated herein in their entireties by reference.

### TECHNICAL FIELD

The present invention relates to equipment for handling microfeature workpieces. More particularly, the present invention is directed to transfer devices having end-effectors for handling microfeature workpieces, and associated control and guidance systems and methods for such end-effectors.

### BACKGROUND

Microelectronic devices are fabricated on and/or in microelectronic workpieces using several different processing apparatuses or tools. Many such processing tools have a single processing station that performs one or more procedures on the workpieces. Other processing tools have a plurality of processing stations that perform a series of different procedures on individual workpieces or batches of workpieces. The workpieces are often handled by automatic handling equipment (e.g., robots or transfer devices) because microelectronic fabrication requires very precise positioning of the workpieces and/or conditions that are not suitable for human access (e.g., vacuum environments, high temperature environments, chemical environments, clean environments, etc.).

An increasingly important category of processing tool is a plating tool that plates metal and other materials onto workpieces. Existing plating tools use automatic handling equipment to handle the workpieces because the position, movement and cleanliness of the workpieces are important parameters for accurately plating materials onto the workpieces. The plating tools can be used to plate metals and other materials (e.g., ceramics or polymers) in the formation of contacts, interconnects and other components of microelectronic devices. For example, copper plating tools are used to form copper contacts and interconnects on semiconductor wafers, field emission displays, read/write heads and other types of microelectronic workpieces. A typical copper plating process involves depositing a copper seed layer onto the surface of the workpiece using chemical vapor deposition (CVD), physical vapor deposition (PVD), electroless plating processes, or other suitable methods. After forming the seed layer, copper is plated onto the workpiece by applying an appropriate electrical field between the seed layer and an anode in the presence of an electrochemical plating solution. The workpiece is then cleaned, etched and/or annealed in subsequent procedures before transferring the workpiece to another tool or apparatus.

Single-wafer plating tools generally have a load/unload station, a number of plating chambers, a number of cleaning chambers, and a transfer mechanism for moving the workpieces between the various chambers and the load/unload station. The transfer mechanism can be a rotary system having one or more robots that rotate about a fixed location in the plating tool. An existing rotary transfer mechanism is shown in U.S. Pat. No. 6,136,163 to Cheung, et al. Alternate transfer mechanisms include linear systems that have an elongated track and a plurality of individual robots that can move independently along the track. Each of the robots on the linear track can also include independently operable end-effectors. Existing linear track systems are shown in: (a) U.S. Pat. Nos. 5,571,325; 6,318,951; 6,752,584; 6,749,390; and 6,322,119; (b) PCT Publication No. WO 00/02808; and (c) U.S. Publication No. 2003/0159921, all of which are incorporated herein in their entireties by reference. Many rotary and linear transfer mechanisms have a plurality of individual robots that can each independently access most, if not all, of the processing stations within an individual tool to increase the flexibility and throughput of the plating tool.

The foregoing robots use end-effectors to carry workpieces from one processing station to another. The nature and design of the end-effectors will depend, in part, on the nature of the workpiece being handled. For example, when the backside of the workpiece may directly contact the end-effector, a vacuum-based end-effector may be used. Such vacuum-based end-effectors typically have a plurality of vacuum outlets that draw the backside of the workpiece against a paddle or other type of end-effector. In other circumstances, however, the workpieces have components or materials on both the backside and the device side that cannot be contacted by the end-effector. For example, workpieces that have wafer-level packaging have components on both the device side and the backside. Such workpieces typically must be handled by edge-grip end-effectors, which contact the edge of the workpiece and only a small perimeter portion of the device side and/or the backside of the workpiece. Edge-grip end effectors accordingly avoid introducing particle contamination on the backside of the workpiece.

Several current edge-grip end-effectors use an active member that moves in the plane of the workpiece between a release position and a grip position to retain the workpiece on the end-effector. In the release position, the active member is disengaged from the workpiece and spaced apart from the workpiece to allow loading/unloading of the end-effector. In a grip position, the active member presses against the edge of the workpiece to drive the workpiece laterally against one or more other edge-grip members in a manner that secures the workpiece to the end-effector. The active member can be a plunger with a groove that receives the edge of the workpiece, and the other edge-grip members can be projections that also have a groove to receive other portions of the edge of the workpiece. In operation, a pneumatic, hydraulic, or piezoelectric motor moves the active member radially outward to the release position for receiving a workpiece and then radially inwardly to the grip position for securely gripping the edge of the workpiece in the grooves of the edge-grip members and the active member.

One concern with the foregoing types of end-effectors is that they typically occupy a relatively large amount of space. However, it is desirable to make the robots as small as possible so as to allow the robots to move easily among the processing stations without interfering with adjacent components. Robots that occupy less space also reduce the overall footprint of the tool. Reducing the footprint of the tool is important because the tool must typically be placed in a clean room or other space that has a tightly controlled environment. Such environments are expensive to build, operate, and maintain. Accordingly, there is a need to reduce the space occupied by tools in such an environment so as to reduce the cost of processing workpieces in the environment.

Another concern of active edge-grip end-effectors is that pneumatic, hydraulic and/or piezoelectric motors are difficult to precisely control. More specifically, such motors may not drive the active member toward the workpiece with an adequate force, or may slip when driving the active member. In other instances, such motors may drive the workpiece with excessive force so that the active member strikes the workpiece too hard and damages the workpiece. Accordingly, there is a need to improve end-effectors to increase the control and reduce the number of complex and expensive components attributed to such end-effectors.

Still another concern of edge-grip end-effectors is accurately determining when a workpiece is securely held in place. Many existing systems use an optical or mechanical flag that provides a signal corresponding to the position of the active member. Although this method is generally suitable, it may give a false positive indication that a workpiece is secured to the end-effector. For example, a workpiece may be askew on the end-effector, such that the active member does not engage the workpiece, but a flag system will still indicate that the workpiece is in place if the active member moves to the grip position. In other instances, the end-effectors may be required to grip wafers having different sizes and/or shapes, and accordingly, the optical or mechanical flag may not provide an adequate indication that such workpieces are gripped. Accordingly, there is also a need to provide a more accurate indication of the relationship between the workpiece and the end-effector that grips it.

Yet another concern of end-effectors is that they include at least one, and in many cases several, rotational joints that allow the end-effectors to be accurately positioned at various locations within the processing tool. When the end-effectors are powered by electrical devices, and/or include electrical sensors, electrical communication must be provided across the rotational joints between components of the end-effectors. Slip rings are often employed to provide such electrical communication, but slip rings can wear out prematurely as a result of the mechanical friction between components of the slip rings. In addition, slip rings are particularly susceptible to contamination by particulates. Accordingly, there is also a need to provide more reliable electrical communication between components of the end-effector.

The present inventors have developed end-effectors that overcome the concerns of existing edge-grip end-effectors. The inventive end-effectors are small, and accurately and firmly grip the workpieces. The end-effectors also have robust electrical connections, and are easy to control. Accordingly, the present inventors have developed end-effectors and associated systems and methods that fulfill the needs unmet by prior art arrangements.

### SUMMARY

The present invention is directed toward end-effectors with components that (a) are easier to control than are existing end-effector components, (b) more accurately grip the microfeature workpieces, (c) occupy less volume than existing arrangements, and/or (d) provide more robust electrical communication links. Because the end-effectors are more accurately controlled, the likelihood that the workpieces they engage will slip or become disengaged during handling is significantly reduced. Furthermore, the orientation of the motor and the elements that couple the motor to the end-effector grippers (which contact the workpiece) can be such as to significantly reduce the volume occupied by the end-effector. As a result, the end-effectors can operate in a confined space while handling 300 mm or larger workpieces (as well as 150 mm, 200 mm or smaller workpieces) in a fast-moving sequence of transfer operations.

In a particular arrangement, a transfer device includes a base unit, an arm carried by the base unit, and an end-effector carried by the arm and rotatable relative to the arm. The end-effector includes two grippers with at least one of the grippers being movable toward and away from the other between a grip position and a release position. A motor is coupled to a transmission which is in turn coupled to the gripper(s) to move the gripper(s). The transmission receives an input force from the motor and applies an output force to the gripper(s) that increases as the gripper(s) move to the grip position. For example, the transmission may include a drive link that is eccentrically connected to a worm gear so that the incremental force applied by the drive link increases as the worm gear rotates. This arrangement allows the grippers to consistently, firmly grip the workpiece, improving the efficiency and throughput of the tool in which it is installed.

In other arrangements, the motor is mounted transverse to a motion axis of the grippers, in a compact arrangement. The motor includes a direct current servomotor having an output shaft, with an encoder positioned to detect rotation of the output shaft. A controller is coupled to the encoder and to the motor and is programmed with instructions to direct the motion of the motor base at least in part on information received from the encoder. This arrangement makes it easier to precisely control the motion of the grippers. In still another aspect, a reel is carried by the arm, the end-effector or both. A flexible communication link (e.g., an electrical lead) is coupled between the arm and the end-effector to provide communication between the arm and a device carried by the end effector (e.g., a motor or sensor). The communication link is wound multiple times around the reel so as to accommodate a preselected amount of relative rotation between the arm and the end-effector, while providing a robust and generally friction-free communication connection between these two components.

### BRIEF DESCRIPTION OF THE DRAWINGS

FIG. 1 is a top plan view of a tool that includes a transfer device for handling microfeature workpieces in accordance with an embodiment of the invention.

FIG. 2 is an isometric view of a portion of a tool with panels removed to expose internal features of the tool.

FIG. 3 is an isometric view of a transfer device for handling microfeature workpieces in accordance with one embodiment of the invention.

FIG. 4A is a partially schematic, partially broken view of an end-effector having a motor, grippers, and a connecting transmission arranged in accordance with an embodiment of the invention.

FIG. 4B is a top plan view of the end-effector shown in FIG. 4A, with the grippers moved to a gripping position.

FIG. 4C is a schematic illustration of an arrangement for controlling an end-effector in accordance with another embodiment of the invention.

FIG. 4D is a flow diagram illustrating processes for operating end-effectors in accordance with an embodiment of the invention.

FIG. 5 is an isometric illustration of a transfer device having end-effectors arranged in accordance with another embodiment of the invention.

FIG. 6 is an isometric illustration of one of the end-effectors shown in FIG. 5.

FIG. 7A is a top plan view of the end-effector shown in FIG. 6.

FIG. 7B is a side elevation view of one of the grippers carried by the end-effector shown in FIGS. 6 and 7A.

FIG. 8A is a top isometric illustration of a hub assembly having a reel configured in accordance with an embodiment of the invention.

FIG. 8B is a top isometric illustration of the hub assembly shown in FIG. 8A, with a cover removed to illustrate internal features.

### DETAILED DESCRIPTION

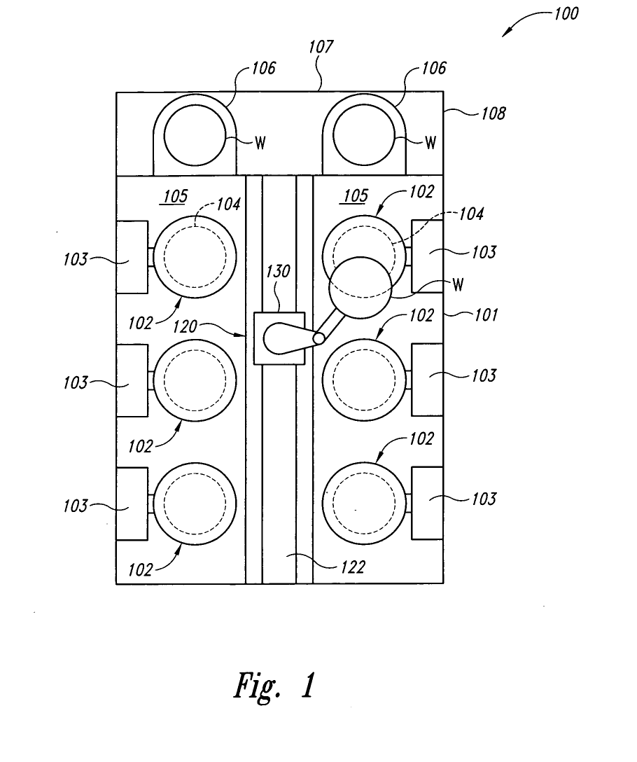

The following description discloses the details and features of several embodiments of end-effectors for handling microfeature workpieces, and methods for using such devices. The terms “microfeature workpiece” or “workpiece” refer to substrates on and/or in which micro-devices are formed. Typical micro-devices include microelectronic circuits or components, thin-film recording heads, data storage elements, micro-fluidic devices, and other products. Micro-machines or micromechanical devices are included within this definition because they are manufactured in much the same manner as integrated circuits. The substrates can be semiconductive pieces (e.g., silicon wafers or gallium arsenide wafers), non-conductive pieces (e.g., various substrates), or conductive pieces (e.g., doped wafers). It will be appreciated that several of the details set forth below are provided to describe the following embodiments in a manner sufficient to enable a person skilled in the art to make and use the disclosed embodiments. Several of the details and advantages described below, however, may not be necessary to practice certain embodiments of the invention. Additionally, the invention may also include other embodiments that are also within the scope of the claims, but are not described in detail with reference to FIGS. 1-8B.

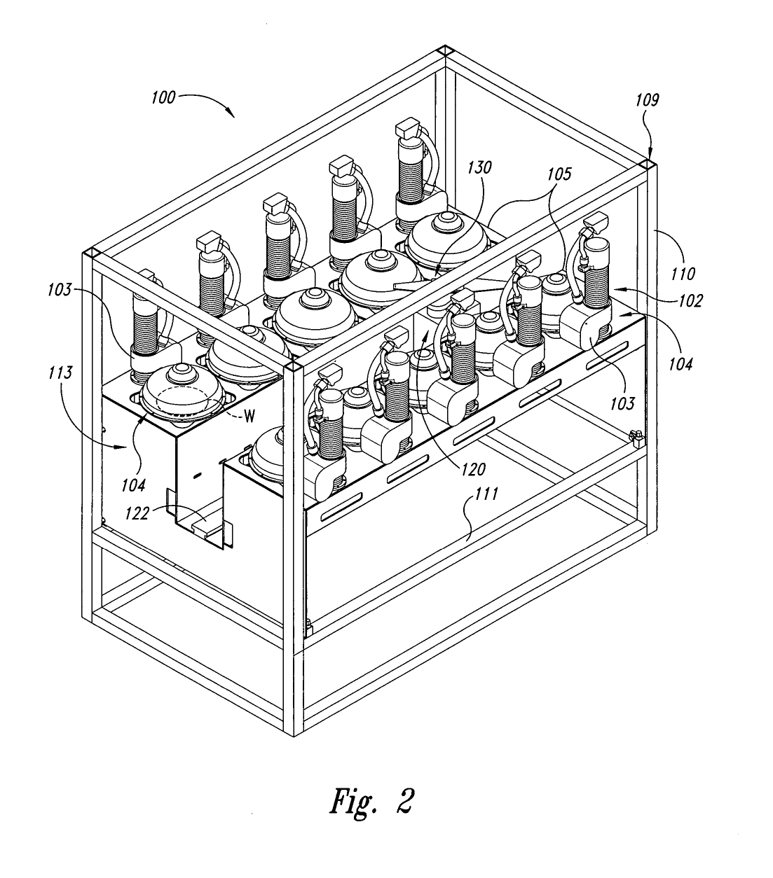

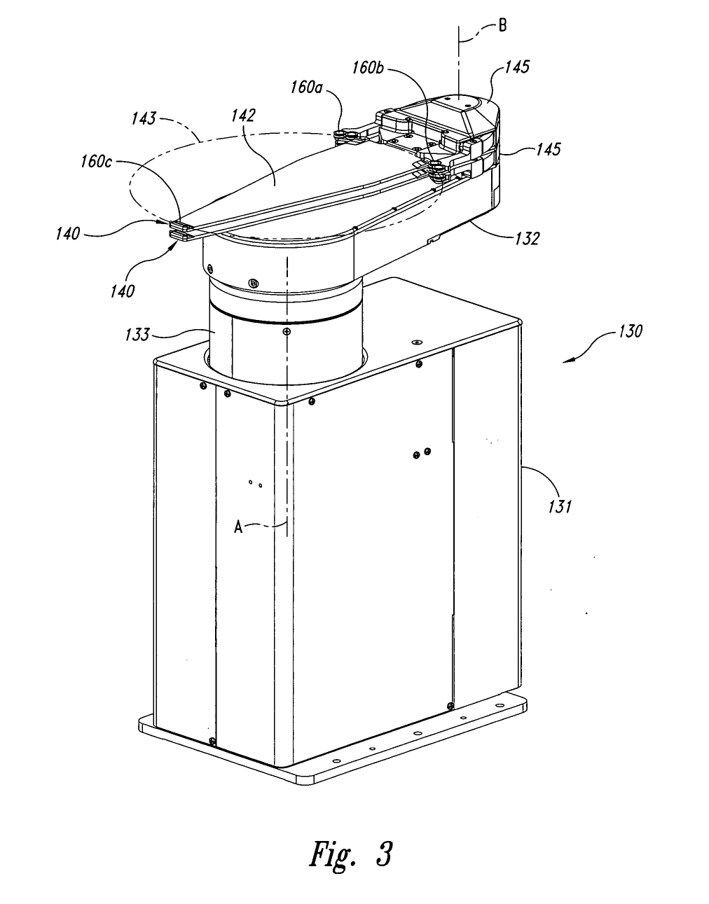

The operation and features of end-effectors for handling microfeature workpieces are best understood in light of the environment and equipment in which they can be used. Accordingly, several embodiments of processing tools and associated transfer devices with which the end-effectors can be used are described with reference to FIGS. 1 and 2. The details and features of several embodiments of end-effectors will then be described with reference to FIGS. 3-8B.

FIG. 1 schematically illustrates an integrated tool 100 that performs one or more wet chemical or other processes. The tool 100 includes a housing or cabinet 101 that encloses a deck 105, a plurality of processing stations 102, and a transport system 120. Each processing station 102 includes a vessel, chamber, or reactor 104 and a workpiece support (for example, a lift-rotate unit) 103 for transferring microfeature workpieces W into and out of the chamber 104. The stations 102 can include rinse/dry chambers, cleaning capsules, etching capsules, electrochemical deposition chambers, annealing chambers, or other types of processing chambers. The transport system 120 includes a linear track 122 and a transfer device or robot 130 that moves along the track 122 to transport individual workpieces W within the tool 100. The integrated tool 100 further includes a workpiece load/unload unit 108 having a plurality of containers 106 for holding the workpieces W. In operation, the transfer device 130 transports workpieces W to/from the containers 106 and the processing stations 102 according to a predetermined workflow schedule within the tool 100. A controller 107 receives inputs from an operator and, based on the inputs, automatically directs the operation of the transfer device 130, the processing stations 102, and the load/unload unit 108.

FIG. 2 is an isometric view showing a portion of an integrated tool 100 in accordance with an embodiment of the invention. The integrated tool 100 includes a frame 109, a dimensionally stable mounting module 113 mounted to the frame 109, and a plurality of processing stations 102, each having a chamber 104 and an associated workpiece support 103. The tool 100 also includes a transport system 120, with the dimensionally stable mounting module 113 carrying the processing chambers 104, the workpiece supports 103, and the transport system 120.

The frame 109 has a plurality of posts 110 and crossbars 111 that are welded together. A plurality of outer panels and doors (not shown in FIG. 2) are generally attached to the frame 109 to form an enclosed cabinet generally similar to the cabinet 101 shown in FIG. 1. The mounting module 113 is housed within the frame 109 and is configured to carry a linear track 122 of the transport system 120 in a fixed dimensional position relative to the process stations 102 to reduce the likelihood for misalignments between the transfer device 130 and the workpiece supports 103. Accordingly, workpieces W are transferred between the transfer device 130 and the workpiece supports 103 with a high degree of accuracy.

FIG. 3 is an isometric illustration of an embodiment of the transfer device 130 with two end-effectors 140. The transfer device 130 includes a base unit 131, a column 133, and an arm 132 carried by the column 133. The arm 132 rotates about an arm rotation axis A relative to the base unit 131, and the base unit 131 itself translates back and forth along the linear track 122 (shown in FIG. 2). The arm 132 carries one or more end-effectors 140 (two are shown in FIG. 3). Each end-effector 140 rotates about an end-effector rotation axis B relative to the arm 132. In the arrangement shown in FIG. 3, both end-effectors 140 rotate about the same end-effector rotation axis B, but in other embodiments, they can rotate about different axes. Each end-effector 140 further includes a housing 145 in which the components that activate the end-effector are carried. These components include motors and associated couplings for moving three grippers 160a-c (referred to collectively as grippers 160). The grippers 160 are positioned around a gripping region 143 which is sized to receive a microelectric workpiece. The first and second grippers 160a-b are positioned toward one side of the gripping region 143, and the third gripper 160c is carried by an elongated blade 142 so as to be generally opposite the first and second grippers 160a-b. In operation, one or more of the grippers 160 move toward and away from one or more of the other grippers to grip and release a workpiece positioned in the gripping region 143.

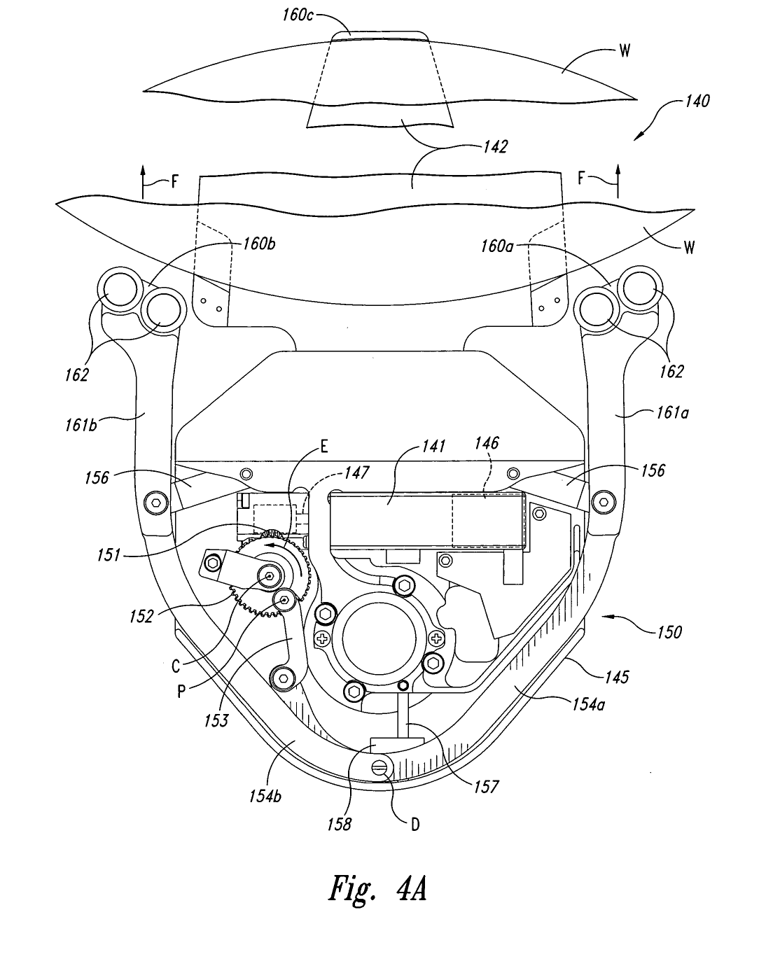

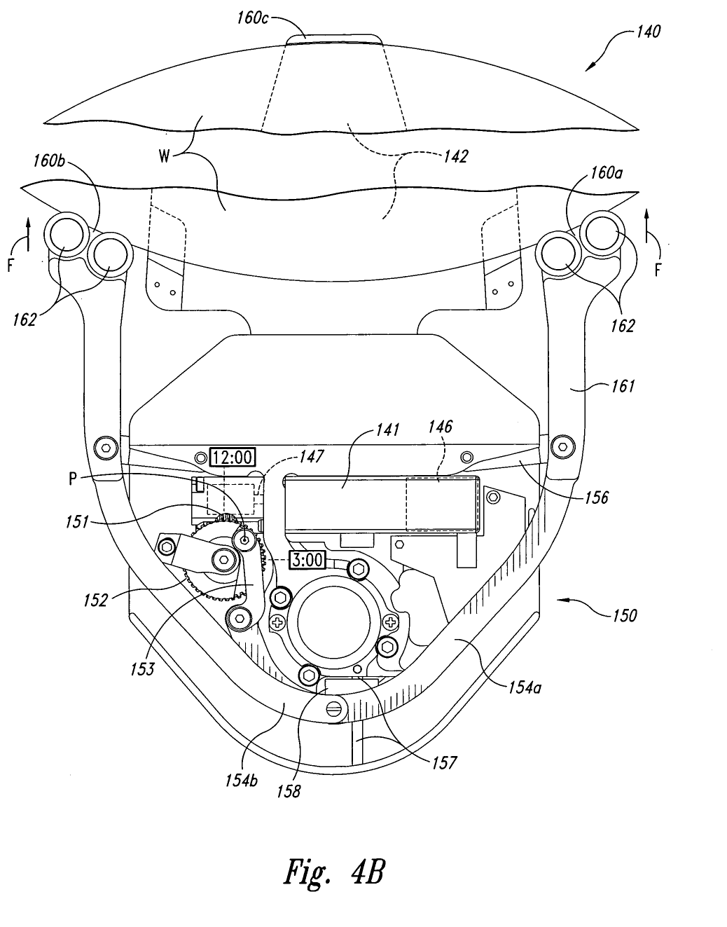

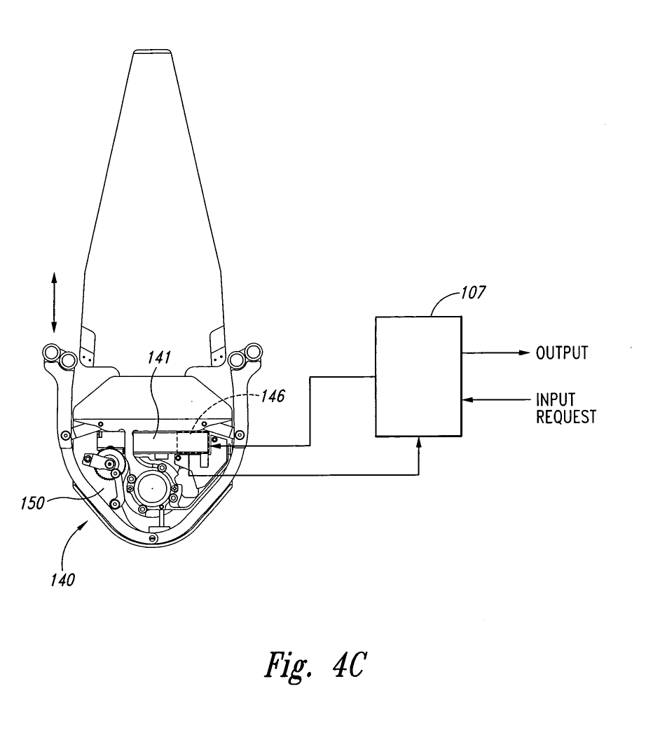

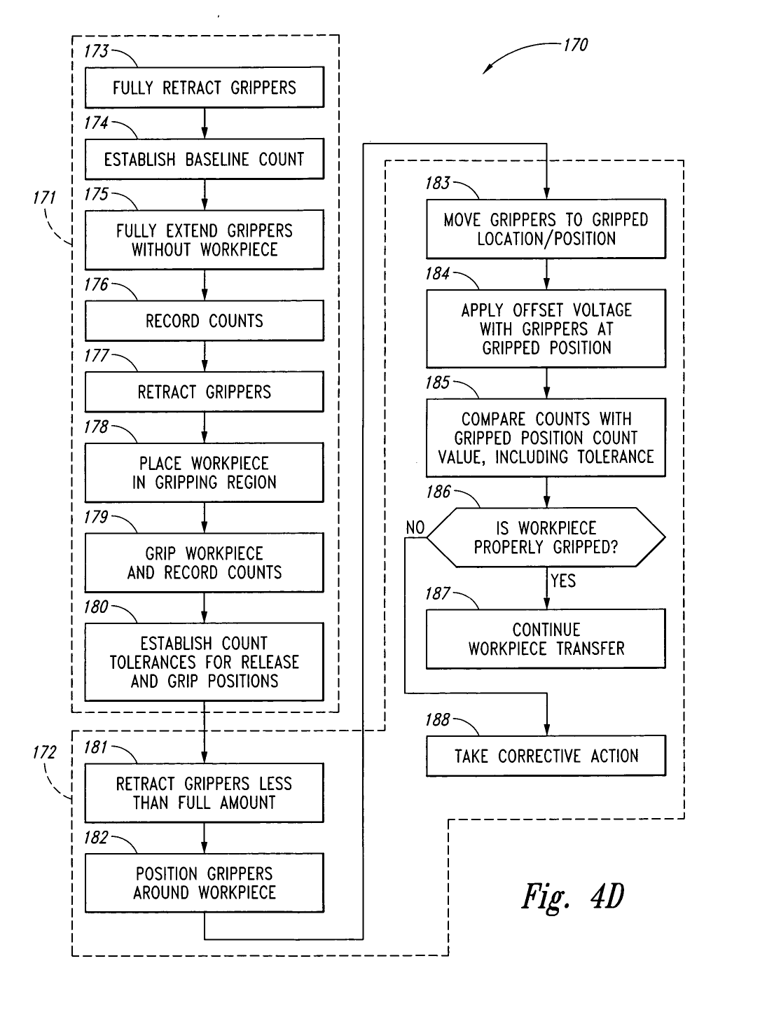

FIG. 4A is an enlarged top plan view of one of the end-effectors 140 shown in FIG. 3, with a portion of the housing 145 removed. A central portion of the blade 142 is also not shown so as to facilitate illustration of all the grippers 160a-c in an enlarged view on a single page. As shown in FIG. 4A, a microfeature workpiece W is positioned in the gripping region 143, with the end-effector 140 in a “release” position. Accordingly, the grippers 160a-c are spaced apart from the edges of the workpiece W. Further details of the arrangement by which the first and second grippers 160a-b are moved between the release position and a “grip” position are described below with reference to FIG. 4A. The grippers 160 are then shown in the grip position in FIG. 4B.

The end-effector 140 includes a motor 141 that is coupled to the first and second grippers 160a-b with a transmission or other coupling arrangement 150. The motor 141 includes a direct current (DC) servomotor having an encoder 146 (shown schematically in FIG. 4A) that tracks the rotations of a motor output shaft 147. As will be described in greater detail below with reference to FIG. 4C, this arrangement allows for precise control of the grippers 160a-b. The motor 141 in this arrangement is also mounted in a transverse fashion relative to the direction in which the grippers 160a-b move, which tends to reduce the footprint of the end-effector 140.

The motor output shaft 147 carries a worm 151 that engages a corresponding worm gear 152. The worm gear 152 rotates about a worm gear rotation axis C. A drive link 153 is eccentrically mounted to the worm gear 152 (eccentric relative to the rotation axis C) so as to move in a curved manner when the worm gear 152 rotates. The drive link 153 is pivotally connected between the worm gear 152 (at pivot point P) and a first yoke link 154a, which is in turn pivotally connected to a first gripper arm 161a. The first gripper arm 161a carries rollers 162 or other gripping elements that make contact with the workpiece W. The motion of the first yoke link 154a is guided by a fixed linear guide rod 157 that is received in a linear guide bearing 158 carried by the first yoke link 154a. The motion of the first gripper arm 161a is guided by a guide link 156 that is pivotally coupled between the first gripper arm 161a and the housing 145. Accordingly, the rollers 162 move toward and away from the target workpiece W with the guidance provided by the linear guide rod 157 and the guide link 156. The motion of the rollers is not entirely linear, due to the presence of the guide link 156. As a result, the outer of the two rollers 162 (e.g., the right-most roller carried by the first gripper arm 161a) engages the workpiece W before the inner roller. This gives the linkage more leverage to center the workpiece W.

The second gripper 160b includes a second gripper arm 161b that also carries a pair of rollers 162. Its motion is guided by a corresponding guide link 156, and is provided by a second yoke link 154b that is pivotally coupled to the first yoke link 154a at a yoke pivot D. When the motor output shaft 147 rotates and drives the worm gear 152 in the direction indicated by arrow E, the drive link 153 pulls the first and second yoke links 154a-b toward the workpiece W, driving the rollers 162 into contact with the workpiece W, as indicated by arrows F. This motion also drives the opposite edge of the workpiece W into contact with the third gripper 160c.

FIG. 4B illustrates the end-effector 140 in the grip position. In this position, all three grippers 160a-c firmly engage a portion of the edge of the workpiece W so that the workpiece W will not slip out from the end-effector 140 as the end-effector 140 moves the workpiece W to a desired location. One reason the end-effector 140 firmly grips the workpiece W is because the transmission 150 provides a mechanical advantage that increases the force with which the grippers 160a-c contact the workpiece W. For example, the worm 151 and worm gear 152 provide a mechanical advantage by converting a relatively large amount of rotational motion provided by the motor output shaft 147, to a relatively small amount of rotational motion provided by the worm gear 142, but a motion that carries an increased level of force.

Another way in which the end-effector 140 firmly grips the workpiece W is by increasing the force applied by the grippers 160a-c as they contact the workpiece W. In particular, the force applied by the drive link 153 to the first yoke link 154a (which is then transmitted to the first and second grippers 160a-b) changes (both upwardly and downwardly) as the grippers 160a-b move to their grip positions. This is so because the drive link 153 is eccentrically attached to the worm gear 142. In particular, when the drive link 153 moves from its release position (shown in FIG. 4A) and the pivot point P moves toward the 3:00 position, the incremental increase in force provided by the grippers 160a-b decreases with each degree of rotation. As the pivot point P passes through the 3:00 position and toward the 12:00 position, the opposite is true. That is, with each degree of rotation beyond the 3:00 position and toward the 12:00 position, the drive link 153 moves the grippers 160a-b in a generally linear direction (indicated by arrows F) by a smaller and smaller amount, but with a greater incremental amount of force. Accordingly, when the first and second grippers 160a-b contact the workpiece W and clamp the workpiece W against the third gripper 160c, they do so with an increased level of force which continues to increase until the clamping operation is complete. As a result, the workpiece W is securely clamped and is therefore less likely to be dropped by the end-effector 140 during the subsequent motion of the end-effector 140. This feature can be particularly important because the dollar value of the workpieces W, particularly toward the end of their processing schedules, is typically very high. Therefore, breaking or otherwise damaging the workpiece W can be a costly manufacturing setback.

Another way by which the operator can more precisely and more consistently engage the workpiece W with the end-effector 140 is by accurately tracking the motion of the grippers 160a-b. The encoder 146, which detects the rotations of the motor output shaft 147 (or another quantity that is correlated with output shaft rotation) facilitates this process, as described in greater detail below with reference to FIGS. 4C and 4D.

FIG. 4C is a schematic illustration of the motor 141, the encoder 146, the controller 107, and the end-effector 140. The controller 107 receives an input request as a result of a directive from a user, or as the result of an automatically executed sequence of events, and provides a motor directive to the motor 141. The controller 107 may also provide an output signal indicating the status of the directive, the status of the input request, and/or the status of the end-effector 140. Accordingly, the controller 107 can include a computer-based programmable medium with instructions for carrying out and responding to various directives. In response to the motor directive, the motor 141 drives the transmission 150 to grip or release the workpiece W, as appropriate. The encoder 146 provides a feedback signal to the controller 107 indicating the progress of the gripping and/or release operation. This information is then used to determine whether or not the operation has been successfully completed, and is also used to further direct the motor 141.

FIG. 4D is a flow diagram illustrating a process 170 for “teaching” the motion of the end-effector 140 using the encoder 146, and then using the end-effector 140 and the encoder 146 to grip a workpiece during normal operation. Accordingly, the process 170 includes a teaching process 171 and an actual operation process 172. The teaching process 171 includes fully retracting the grippers (process portion 173) and establishing a baseline encoder count value, provided by the encoder (process portion 174). The encoder counts correspond to the amount by which the motor output shaft rotates. The grippers are then fully extended without a workpiece present in the gripping region (process portion 175). The counts at the fully extended position are then recorded (process portion 176) and the grippers are retracted (process portion 177) either to the fully retracted/release position, or to another retracted or release position that is sufficient to accommodate the workpiece. The workpiece is then placed in the gripping region (process portion 178) and the grippers are extended to fully and firmly grip the workpiece (process portion 179). The counts provided by the encoder are also recorded at this position.

In process portion 180, a count tolerance is established for both the release position and the grip position. The count tolerance accounts for expected slight manufacturing differences between wafers of a similar class (and, optionally, processing history). For example, 300 mm wafers complying with industry standards are expected to have a diameter that falls within a relatively small range. The number of counts corresponding to the release position is adjusted to allow for wafers at either extreme of the diameter range, as are the number of counts corresponding to the grip position. Accordingly, the end-effector has instructions that allow it to operate with workpieces having diameters within an expected tolerance range.

During actual operation, identified by process portion 172, the grippers are retracted by less than their full amount, but far enough to accommodate workpieces within the expected tolerance range, plus an additional margin to account for variations in the position of the workpiece within a chamber or input/output cassette (process portion 181). In process portion 182, the grippers are positioned around a workpiece (e.g., by moving the end-effector proximate to the workpiece), and in process portion 183, the grippers are moved to the grip position or location. In process portion 184, an offset voltage is applied to the motor with the grippers at the grip position. If the grippers can move beyond the grip position (including the tolerance range), this is an indication that the workpiece is not present or is not properly gripped. Accordingly, in process portion 185, the counts corresponding to the pre-established grip position are compared with the actual count value recorded by the encoder. In process portion 186, if the workpiece is not properly gripped, corrective action is taken (process portion 188). The corrective action may include alerting the operator to an improperly gripped workpiece, shutting down the end-effector and/or the transfer device that carries it, and/or another appropriate action. If the workpiece is properly gripped, based on the feedback received from the encoder, then the workpiece transfer process continues (process portion 187).

One feature of the illustrated end-effector 140 described above with reference to FIGS. 3-4D is that the motor 141 is arranged so that the motor output shaft 147 is transverse to the direction in which the grippers move (arrows F in FIG. 4A). As a result, the dimension of the end-effector 140 in this direction can be reduced compared with existing end-effectors having motors aligned parallel to the motion path. As a result, the volume occupied by the end-effector 140 and the footprint presented by the end-effector 140 are less than the corresponding values for existing end-effectors. One advantage of this feature is that the end-effector 140 is less likely to interfere with other components in the tool within which it is positioned. Still another advantage is that the overall size of the tool may be reduced due to the compact nature of the end-effector 140. Yet another advantage is that the end-effector 140 may more readily accommodate workpieces larger than 300 mm, which the industry is likely to move toward. All of these features increase the overall efficiency of the end-effector 140 and corresponding tool, and reduce the costs associated with operating the tool.

Another feature of the illustrated end-effector 140 is that the motor 141 includes a DC servomotor with an encoder 146. The encoder 146 accurately tracks the rotation of the motor output shaft 147 (or a corresponding quantity) which in turn allows the operator to very accurately position the grippers 160. This feature reduces the likelihood for the grippers 160 to improperly engage a workpiece without the operator's knowledge. Still further, the positional accuracy provided by the encoder 146 allows the controller 107 to accelerate and decelerate the grippers 160, as appropriate. For example, the controller 107 can decelerate the grippers 160 just prior to contact with the workpiece W to soften the contact forces, then accelerate the grippers 160 at other times to increase the speed with which the grip and release operations are performed. As a result, these features also increase the efficiency and utility of the tool in which the grippers are placed.

Still another feature of the illustrated end-effector 140 is that the transmission 150 changes (e.g., increases) the incremental force applied by the grippers 160 as they approach their grip positions. For example, the eccentric arrangement between the drive link 153 and the worm gear 142 facilitates an increase in output force as the grip position is attained. The DC servomotor 141 also allows the force to be controlled by controlling the current applied to the motor. Information received from the encoder 146 may be used to determine when to increase or decrease the force provided by the motor 141. An advantage of these features is that the grippers 160 are more likely to completely and firmly engage the workpiece W, thereby reducing the likelihood that the workpiece W will be only loosely engaged, dropped, or otherwise mishandled during subsequent motion of the end-effector 140. This in turn significantly improves the throughput of the tool in which the end-effector 140 is housed.

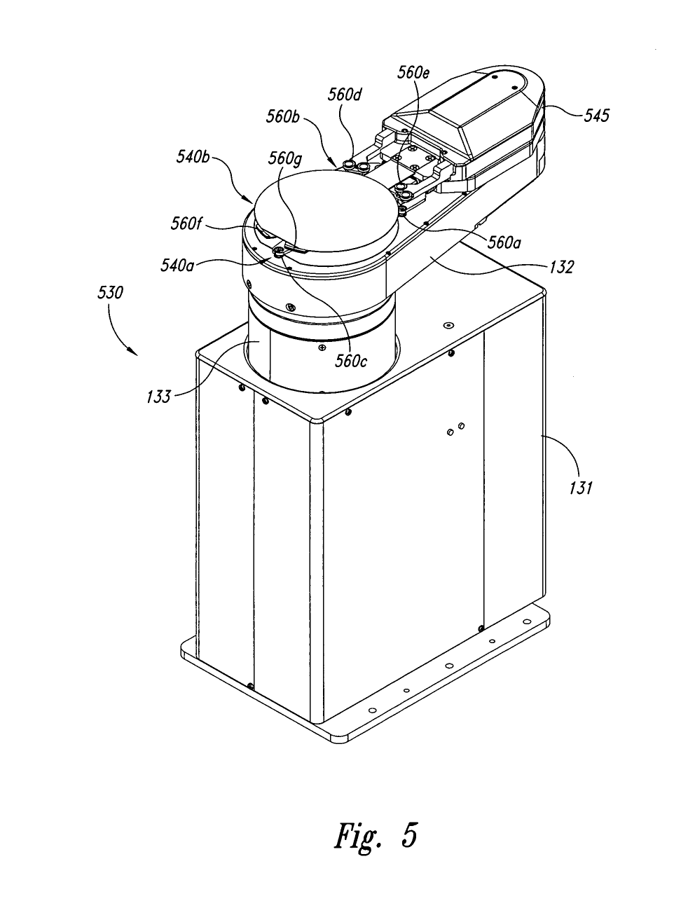

FIG. 5 is an isometric illustration of a transfer device 530 configured in accordance with another embodiment. The transfer device 530 includes a base unit 131, a column 133, and an arm 132, generally similar to the corresponding components described above with reference to FIG. 3. The arm 132 carries two end-effectors including a first or lower end-effector 540a and a second or upper end-effector 540b protected by a housing 545. In an arrangement shown in FIG. 5, the upper and lower end-effectors 140a, 140b have different configurations so as to serve different processing chambers. In other embodiments, these end-effectors can have the same configuration.

The arrangement shown in FIG. 5 illustrates the lower end-effector 540a having a first gripper 560a and a second gripper 560b (hidden in FIG. 5), both positioned opposite from a third gripper 560c. The second or upper end-effector 540b includes four grippers, including first and second grippers 560d and 560e positioned on one side of a corresponding workpiece W, and third and fourth grippers 560f, 560g positioned on the opposite side of the workpiece W. Each of the end-effectors 540a-b is configured to handle a particular workpiece W, or handle a particular workpiece W in a particular manner. For example, the first end-effector 540a is configured to reach over a workpiece W and clamp its edges, while the second end-effector 540b is configured to reach under the workpiece W to clamp its edges.

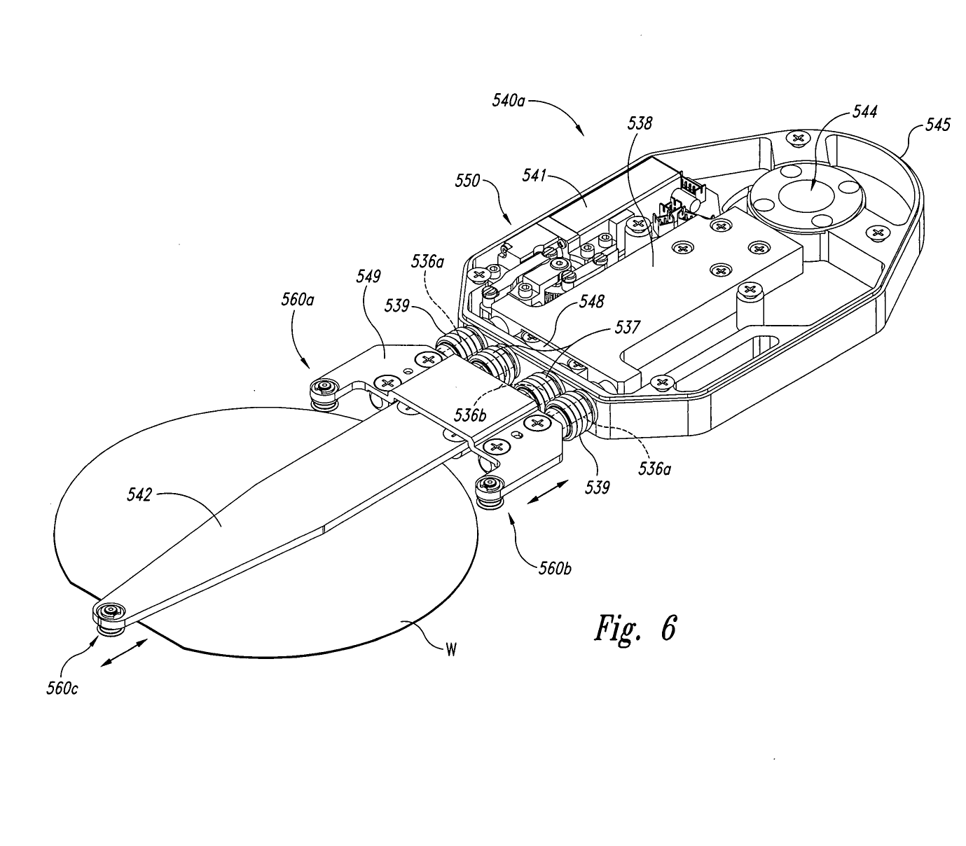

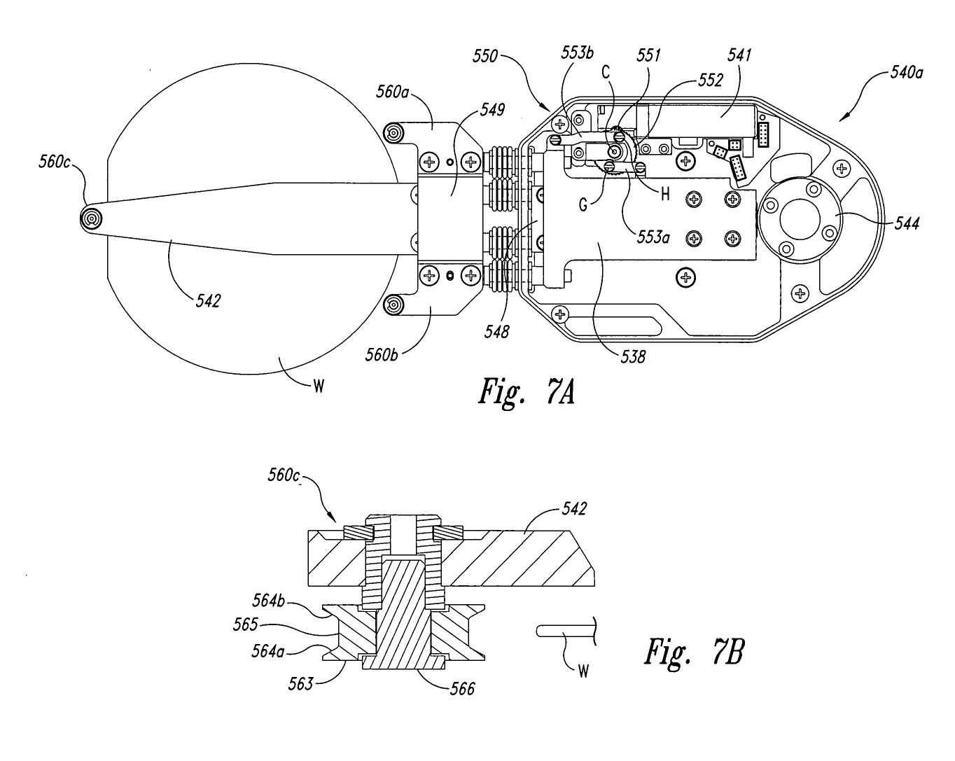

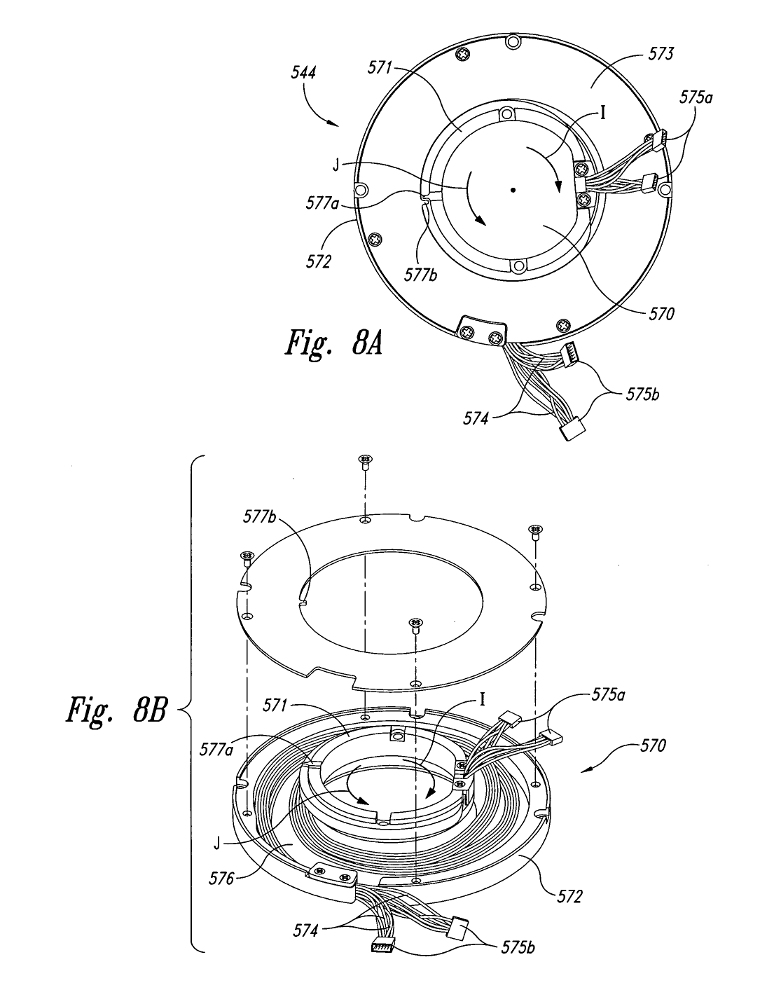

FIG. 6 illustrates an isometric view of the first or lower end-effector 540a shown in FIG. 5, with a portion of the housing 545 removed. The first end-effector 540a includes a yoke 549 carrying the first and second grippers 560a-b, and a blade 542 carrying the third gripper 560c. Both the yoke 549 and the blade 542 are actuated so as to move between a release position and a grip position. Accordingly, the yoke 549 is connected to a yoke carriage 538 via yoke drive rods 536a. The blade 542 is connected to a blade carriage 548 via blade drive rods 536b. The blade drive rods 536b are protected by blade seals 537, and the yoke drive rods 536a are protected by yoke seals 539. Accordingly, when the first end-effector 540a is used in a chemically harsh environment, the components within the housing 545 are protected from exposure to such chemicals. Components external to the housing 545 are formed from plastics and/or other materials selected for their resistance to the chemical environment. This arrangement is expected to be particularly useful for processing porous silicon, which typically includes exposure to HF and/or other highly corrosive substances.

The blade carriage 548 is guided along a linear path by an internal linear guide (not visible in FIG. 5) and the yoke carriage 538 is guided along a parallel and overlying linear path by the blade carriage 548, which is slideably received in an aperture of the yoke carriage 538. The yoke carriage 538 and the blade carriage 548 are both connected to a motor 541 via a transmission 550. As is discussed in greater detail below with reference to FIGS. 7A-7B, the motor 541 and the transmission 550 are configured to simultaneously move the blade 542 and the yoke 549 during actuation.

FIG. 7A is a top plan view of the first end-effector 540a, shown in its release position. Accordingly, the grippers 560a-c are retracted away from the workpiece W. The transmission 550 transmits the force put out by the motor 541 in a manner that increases the force applied by the grippers 560a-c as the grippers reach their grip positions. Accordingly, in the illustrated arrangement, the transmission 550 includes a worm 551 driven by the motor 541, and a worm gear 552 engaged with the worm 551 and rotatable about a worm gear rotation axis C. The worm gear 552 is connected to two drive links 553, shown as a blade drive link 553a connected between the worm gear 552 and the blade carriage 548, and a yoke drive link 553b connected between the worm gear 552 and the yoke carriage 538. As the worm gear 552 rotates about the worm gear rotation axis C, the drive links 553a-b are driven in opposite directions to move the blade carriage 548 and the yoke carriage 538 toward or away from each other simultaneously. Accordingly, the first and second grippers 560a-b move simultaneously toward or away from the third gripper 560c.

As shown in FIG. 7A, the drive links 553a-b are mounted eccentrically relative to the worm gear rotation axis C at pivot points G and H, respectively. Accordingly, the incremental forces applied by the drive links 553a are at a minimum when the blade pivot points G and H are at the 12:00 and 6:00 positions, respectively, and increase as the blade pivot points G, H are rotated from these positions. In the arrangement shown in FIG. 7A, the blade drive link 553a rotates counterclockwise from the 6:00 position to its grip position, and the yoke drive link 553b rotates counterclockwise from the 12:00 position to its grip position. As discussed above with reference to FIG. 4B, an advantage of increasing the incremental force applied by the grippers 560a-c as they approach the grip position is that the grippers more firmly engage the workpiece W and are therefore less likely to mishandle the workpiece W.

An additional advantage of an arrangement shown in FIG. 7A is that both the blade 542 and the yoke 549 move simultaneously during the release and grip processes. This arrangement can increase the accuracy with which the workpiece is positioned, particularly when it is released. Further details are described below with reference to FIG. 7B.

FIG. 7B is a cross-sectional side view of the third gripper 560c and a portion of the microfeature workpiece W. The third gripper 560c includes a roller 563 pivotally connected to the blade 542 with a roller pin 566. The roller 563 includes upper and lower beveled guide surfaces 564a-b and an intermediate contact surface 565. When the microfeature workpiece W is engaged by the gripper 560c, it tends to bear directly against the contact surface 565, typically at or near the intersection between the contact surface 565 and the lower beveled guide surface 564b. If the gripper 560c were fixed, then during the release process (while the first and second grippers 560a-b, shown in FIG. 7A retract), the microfeature workpiece W tends to slide along the lower beveled guide surface 564b when it becomes unsupported by the first and second grippers 560a-b. This effect may result in different microfeature workpieces W behaving in different, unpredictable manners during the release process. Accordingly, an aspect of the end-effector 540a is that the third gripper 560c moves simultaneously with the first and second grippers 560a-b. This is expected to reduce the likelihood that the microfeature workpiece W will remain engaged with one of the grippers (e.g., the third gripper 560c) during the release process, and is further expected to increase the precision with which the microfeature workpiece W is positioned after release.

Returning briefly to FIG. 6, the end-effector 540a includes a hub assembly 544 that rotatably connects the end-effector 540a to the arm 132 shown in FIG. 5. The hub assembly 544, in addition to providing the rotational connection between the end-effector 540a and the arm 132, also provides the location at which electrical signals are communicated back and forth between the arm 132 and the end-effector 540a, despite the relative rotational movement of these two components. FIGS. 8A-8B illustrate a particular arrangement for facilitating this communication.

Referring first to FIG. 8A, the hub assembly 544 is arranged to include a reel 570. The reel 570 includes an inner hub 571, an outer hub 572, and a cover 573 that protects the interior region between the inner hub 571 and the outer hub 572. The inner hub 571 is connected to an end-effector (e.g., the first end-effector 540a, shown in FIG. 6), and the outer hub 572 is connected to the associated arm 132 (also shown in FIG. 6). One or more flexible electrical leads 574 are carried by the reel 570 and are attached between inner connectors 575a and outer connectors 575b. In an arrangement shown in FIG. 8A, several flexible leads 574 are connected between one pair of inner and outer connectors 575a, 575b, and additional flexible leads 574 are connected between another pair of inner and outer connectors 575a, 575b. Each flexible lead 574 includes one or more wires or other conductive media that transmit electrical signals between the inner connectors 575a and the outer connectors 575b. The flexible leads 574 can be individual insulated wires, or a flat composite of insulated wires, or a bundle of wires. For example, the leads 574 in a particular embodiment are formed using etched flexible circuit techniques. The inner connectors 575a are coupled to electric motors, sensors, and/or other elements carried by the end-effector 540a (FIG. 6) and the outer connectors 575b are carried by the arm 132 (FIG. 6).

FIG. 8B illustrates the reel 570 with the cover 573 removed to show a lead channel 576 located between the inner hub 571 and the outer hub 572. The flexible leads 574 are wrapped multiple times around the inner hub 571 in the lead channel 576. When the inner hub 571 rotates clockwise relative to the outer hub 572 (indicated by arrow 1), the flexible leads are drawn inwardly in a spiral fashion onto the inner hub 571. When the inner hub 571 rotates in the opposite direction (indicated by arrow J), the flexible leads 574 rotate spirally outwardly until they are pressed against the outer hub 572. In this manner, the reel 570 supports a limited degree of relative rotation between the inner hub 571 and the outer hub 572. In an arrangement shown in FIG. 8B, the flexible leads 574 are wrapped several times around the inner hub 571 to allow relative rotation of slightly less than 360° between the inner hub 571 and the outer hub 572. A mechanical stop arrangement (e.g., a first tab 577a carried by the inner hub 571, and a second tab 577b carried by the cover 573) prevents over-rotation in either direction so that at the ends of the rotation range of the reel 570, the flexible leads 574 are not subjected to undo tensions or other forces. The circumferential extent of the second tab 577b can be made larger to reduce the relative rotation between the inner and outer hubs 571, 572. In other embodiments, the mechanical stop arrangement has other configurations.

One feature of an arrangement of the reel 570 shown in FIGS. 8A-8B is that it allows for a significant degree of relative rotation between the end-effector 540a and the arm 132, without the need for slip rings. An advantage of this arrangement is that slip rings tend to wear out and are subject to contamination by particulates, which increases the rate at which the slip rings wear out. By eliminating slip rings and providing a more robust electrical connection between rotating components, the reel 570 and the flexible leads 574 increase the reliability of the end-effector in which they are installed and therefore reduce the need for maintenance which in turn increases the throughput of the associated tool. These features can also increase tool reliability and mean time between failures.

In the arrangement shown in FIGS. 8A-8B, the reel 570 carries one or more electrical leads, as discussed above. In other embodiments, the reel 570 carries other communication links that couple with devices carried by a moving end effector. For example, the end effector may carry a hydraulic or pneumatic actuator, and in such instances, the communication link includes a hydraulic line or a pneumatic line, respectively. In other embodiments, the communication link includes a fiber optic cable, or another suitable medium. In any of these embodiments, the communication link is wound onto and off of the reel in the manner described above.

From the foregoing, it will be appreciated that specific embodiments of the invention have been described herein for purposes of illustration, but that various modifications may be made with deviating from the invention. For example, aspects of the end-effectors described with reference to FIGS. 3-4D may be combined with aspects of the end-effectors described with reference to FIGS. 5-8B. The transmission arrangement powered by the DC servomotors in the illustrated embodiments may be powered by other devices (e.g., pneumatic motors, hydraulic motors, piezoelectric devices, etc.) in other embodiments, while still providing the disclosed increase in incremental force. The motors may have a rotary output, as shown in the Figures, or other outputs (e.g., linear outputs). The transfer device may move along an arcuate rather than a linear path. The encoders discussed above can be replaced with other sensors that provide feedback with the requisite degree of precisive and accuracy. In still further embodiments, certain aspects of the arrangements shown in any of these embodiments may be eliminated. For example, in at least some embodiments, the end-effectors can be mounted directly to a base or other structure, without an intermediate rotating arm. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited except as by the appended claims.

I/We claim:

1. A transfer device for microfeature workpieces, comprising:
a base unit;
an arm carried by the base unit and movable relative to the base unit; and
an end-effector carried by the arm and rotatable relative to the arm, the end-effector including:
two grippers positioned at a gripping region that receives a microfeature workpiece, including a movable gripper that is movable toward and away from another gripper between a grip position and a release position;
a motor; and
a transmission coupled between the motor and the movable gripper to receive an input force from the motor and apply an output force to the gripper that increases as the movable gripper moves to the grip position.

2. The transfer device of claim 1 wherein the transmission includes a gear that rotates about a rotation axis, and a drive link pivotably connected to the gear at a pivot point that is eccentric relative to the rotation axis.

3. The transfer device of claim 1 wherein the output force decreases during motion from the release position to an intermediate point, and increases during motion from the intermediate point to the grip position.

4. The transfer device of claim 1 wherein the end-effector includes another gripper positioned on the same side of the gripping region as the movable gripper, and wherein the transmission includes:
a worm coupled to the motor;
a worm gear engaged with the worm and having a rotation axis;
a drive link pivotably connected to the worm gear at a pivot point that is eccentric relative to the rotation axis;
a first yoke link pivotably coupled between the drive link and the movable gripper;
a second yoke link pivotably coupled between the first yoke link and the other gripper to move the other gripper; and
a linear guide coupled to at least one of the first and second yoke links.

5. The transfer device of claim 1 wherein each of the grippers is coupled to the motor to move toward and away from the other.

6. The transfer device of claim 5 wherein the transmission includes:
a worm coupled to the motor;
a worm gear engaged with the worm and having a rotation axis;
a first drive link pivotably connected to the worm gear at a pivot point that is eccentric relative to the rotation axis, the first drive link being operatively coupled to the movable gripper; and
a second drive link pivotably connected to the worm gear at a pivot point that is eccentric relative to the rotation axis, the second drive link being operatively coupled the other gripper.

7. The transfer device of claim 1 wherein the end-effector is rotatable relative to the arm about an end-effector rotation axis, and wherein each of the grippers is coupled to the motor to move toward and away from the other along a motion axis that passes through the gripping region and the rotation axis.

8. The transfer device of claim 1 wherein the motor includes a motor shaft that is oriented generally transverse to an axis along which the movable gripper moves between the release and the grip position.

9. The transfer device of claim 8 wherein the end-effector is one of two end-effectors both of which are rotatable relative to the arm assembly about the end-effector rotation axis.

10. The transfer device of claim 1 wherein the end-effector is one of two end-effectors carried by the arm assembly.

11. The transfer device of claim 1 wherein one of the grippers includes a single contact element positioned to contact the edge of a microfeature workpiece, and wherein another of the grippers includes at least two contact elements positioned to contact the edge of the microfeature workpiece.

12. The transfer device of claim 1 wherein the motor includes a direct current servomotor.

13. The transfer device of claim 11, further comprising an encoder positioned to detect rotation of a shaft of the motor.

14. The transfer device of claim 11, further comprising a controller coupled to the encoder and the motor, the controller being programmed with instructions to direct the motion of the motor based at least in part on information received from the encoder.

15. The transfer device of claim 1 wherein the controller is programmed to decelerate the motor prior to contact between the grippers and the microfeature workpiece.

16. The transfer device of claim 1, further comprising:
a reel carried by the arm or the end-effector; and
a flexible, elongated communication link coupled between the arm and the end-effector to provide communication between the arm and the end-effector, the link being wound multiple times around the reel.

17. The transfer device of claim 16 wherein the communication link includes an electrical lead.

18. A transfer device for microfeature workpieces, comprising:
a base unit;
an end-effector operatively coupled to the base unit and rotatable relative to the base unit, the end-effector including:
at least two grippers positioned at a gripping region that receives a microfeature workpiece, including a movable gripper that is movable toward and away from another gripper between a grip position and a release position;
drive means for moving the movable gripper, the drive means being configured to apply a force to the movable gripper that increases as the movable gripper moves to the grip position.

19. The transfer device of claim 18 wherein the drive means includes an electric motor coupled to a transmission.

20. The transfer device of claim 19 wherein the transmission includes a gear that rotates about a rotation axis, and a drive link pivotable connected to the gear at a pivot point that is eccentric relative to the rotation axis.

21. The transfer device of claim 19 wherein the motor includes a direct current servomotor.

22. The transfer device of claim 18 wherein the end-effector includes another gripper positioned on the same side of the gripping region as the movable gripper, and wherein the drive means includes:
a motor;
a worm coupled to the motor;
a worm gear engaged with the worm and having a rotation axis;
a drive link pivotably connected to the worm gear at a pivot point that is eccentric relative to the rotation axis;
a first yoke link pivotably coupled between the drive link and the movable gripper;
a second yoke link pivotably coupled between the first yoke link and the other gripper to move the other gripper; and
a linear guide coupled to at least one of the first and second yoke links.

23. The transfer device of claim 18 wherein each of the grippers is coupled to the drive means to move toward and away from the other.

24. The transfer device of claim 23 wherein the end-effector is one of two end-effectors, both of which are rotatable relative to the arm assembly about the end-effector rotation axis.

25. The transfer device of claim 18, further comprising an arm coupled between the base unit and the end-effector, and wherein the arm is rotatably coupled to the base unit and the end-effector is rotatably coupled to the arm.

26. A transfer device for microfeature workpieces, comprising:
a base unit;
an arm carried by the base unit and movable relative to the base unit;
an end-effector carried by the arm and rotatable relative to the arm, the end-effector including multiple grippers;
a reel carried by the arm, the end-effector or both; and
a flexible communication link coupled between the arm and the end-effector to provide communication between the arm and the end-effector, the communication link being wound multiple times around the reel.

27. The transfer device of claim 26, further comprising a stop coupled between the end-effector and the arm to prevent overrotation of the end-effector beyond a rotation limit provided by the flexible communication link.

28. The transfer device of claim 26 wherein the end-effector is positioned to pass over the microfeature workpiece to position the grippers on opposite sides of the workpiece.

29. The transfer device of claim 26 wherein the communication link includes an electrical communication link, and wherein the transfer device further comprises an electrical device coupled to the electrical communication link.

30. The transfer device of claim 29 wherein the electrical communication link includes a generally flat arrangement of multiple electrical conductors.

31. The transfer device of claim 29 wherein the electrical communication link is one of multiple electrical communication links coupled between the arm and the end-effector.

32. The transfer device of claim 29 wherein the electrical device includes an electric motor coupled to a movable gripper to move the movable gripper relative to another gripper.

33. The transfer device of claim 29 wherein the reel includes an inner hub positioned within an outer hub, the inner hub being fixed relative to one of the end-effector and the arm, the outer hub being fixed relative to the other of the end-effector and the and the arm, the outer hub being fixed relative to the other of the end-effector and the arm, and wherein the electrical communication link is positioned between the inner and outer hubs, the electrical communication link coiling onto the inner hub due to relative rotation between the inner and outer hubs in a first direction, the electrical communication link uncoiling from the inner hub due to relative rotation between the inner and outer hub in a second direction opposite the first direction.

34. A transfer device for microfeature workpieces, comprising:
a base unit;
an arm carried by the base unit and movable relative to the base unit; and
an end-effector carried by the arm and rotatable relative to the arm, the end-effector including:
at least two grippers positioned at a gripping region that receives a microfeature workpiece, at least one of the grippers being a movable gripper that is movable toward and away from another gripper between a grip position and a release position;
a direct current servomotor having an output shaft operatively coupled to the movable gripper;
an encoder positioned to detect rotation of the output shaft; and
a controller coupled to the encoder and the motor, the controller being programmed with instructions to direct the motion of the motor based at least in part on information received from the encoder.

35. The transfer device of claim 34 wherein the controller is programmed with instructions to:
move the movable gripper to the grip position;
direct the motor to continue advancing the movable gripper beyond the grip position; and
based on feedback from the encoder, provide an indication as to whether the movable gripper has properly engaged the microfeature workpiece.

36. The transfer device of claim 34 wherein the controller is programmed with instructions to selectively accelerate and decelerate at least one of the grippers.

37. The transfer device of claim 34 wherein the controller is programmed to identify a workpiece diameter, based on feedback from the encoder.

38. The transfer device of claim 34 wherein the controller is programmed to receive input corresponding to a tolerance range for a workpiece diameter.

39. A method for transferring a microfeature workpiece, comprising:
positioning a transfer device proximate to the microfeature workpiece, the transfer device having a base unit, an arm assembly movable relative to the base unit, and an end-effector carried by the arm;
rotating the end-effector relative to the arm about a rotation axis;
moving a movable one of at least two grippers toward the other from a release position to a grip position to engage portions of an edge of the microfeature workpiece; and
increasing a force with which the movable gripper is moved as the movable gripper moves toward the grip position.

40. The method of claim 39 wherein moving the movable gripper includes moving two grippers toward each other to grip the workpiece and away from each other to release the workpiece.

41. The method of claim 39, further comprising:
passing the end-effector over and above the microfeature workpiece; and
moving the end-effector downwardly toward the microfeature workpiece after passing the end-effector over and above the microfeature workpiece, and before moving movable gripper toward another gripper.

42. The method of claim 39 wherein increasing the force includes rotating a gear about a rotation axis while a drive link connected to the gear rotates relative to the gear about an axis that is eccentric relative to the rotation axis.

43. The method of claim 39, further comprising decreasing an amount of force transmitted to the movable gripper as the movable gripper moves from the release position to an intermediate position, and increasing the force transmitted to the movable gripper as the movable gripper moves from the intermediate position to the grip position.

44. A method for transferring a microfeature workpiece, comprising:
positioning a transfer device proximate to the microfeature workpiece, the transfer device having a base unit, an arm movable relative to the base unit, and an end-effector carried by the arm;
moving the end-effector to position grippers carried by the end-effector in a spaced apart arrangement with the microfeature workpiece between the grippers;
activating a rotary electric motor coupled to a movable one of the grippers;
sensing an amount by which the motor rotates; and
directing further activation of the motor and motion of the movable gripper based at least in part on the sensed amount by which the motor rotates.

45. The method of claim 44, further comprising controlling a force applied by the movable gripper by controlling a current applied to the motor.

46. The method of claim 44, further comprising identifying a target workpiece diameter, based at least in part on the sensed amount by which the motor rotates when the grippers grip the motor.

47. The method of claim 46 wherein directing further activation includes directing further activation when subsequent workpieces are carried by the transfer device, based at least in part on the determined workpiece diameter.

48. The method of claim 46, further comprising adding a tolerance range to a baseline target workpiece diameter.

49. A method for transferring a microfeature workpiece, comprising:
positioning a transfer device proximate to the microfeature workpiece, the transfer device having a base unit, an arm movable relative to the base unit, and an end-effector carried by the arm;
providing electrical communication between the end-effector and the arm via a coiled electrical lead;
rotating the end-effector relative to the arm about a rotation axis in a first direction so as to unwind the electrical lead from a reel while providing electrical communication between the end-effector and the arm;
rotating the end-effector relative to the arm about the rotation axis in a second direction opposite the first so as to wind the electrical lead on the reel while providing electrical communication between the end-effector and the arm; and
engaging the workpiece with grippers carried by the end-effector.

50. The method of claim 49 wherein providing electrical communication includes providing electrical power to a motor carried by the end-effector

51. The method of claim 49 wherein providing electrical communication includes providing electrical signals from a sensor carried by the end-effector

52. The method of claim 49, further comprising stopping relative rotation of the inner and outer hub before relative rotation is stopped by mechanical forces applied to the electrical lead.

53. The method of claim 52 wherein stopping relative rotation includes engaging a first portion of a mechanical stop with a second portion of the mechanical stop.
